(19) United States
(12) Patent Application Publication
(10) Pub. No.: US 2007/0088798 A1
(43) Pub. Date: Apr. 19, 2007

(54) Encapsulation of complex business logic

(75) Inventors: John W. Merrill, Redmond, WA (US); Karim Batthish, Seattle, WA (US); Huw Upshall, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/329,552

(22) Filed: Jan. 11, 2006

Related U.S. Application Data
(60) Provisional application No. 60/715,412, filed on Sep. 9, 2005.

(51) Int. Cl. G06F 15/16

(52) U.S. Cl. 709/217

(57) ABSTRACT

A complex business logic encapsulation system and method are provided. The system can encapsulate complex business logic, for example, for workflow application(s). The system includes a common business logic layer component that encapsulates the business logic of objects in a store. The common business logic layer can employ response objects which encapsulate the business logic of complex objects in the store. The response object provides one or more suitable responses. The client can then identify the appropriate response, populate the response and send it back to the common business logic layer component. Each response object can embed an invariant identifier of the store item to which it corresponds, and, when sent or saved through a web service, causes the store to behave as if it had been processed by system.

### CROSS REFERENCE TO RELATED APPLICATION(S)

This application claims benefit under 35 U.S.C. § 119(e) from U.S. Provisional Patent Application Ser. No. 60/715,412, entitled “ENCAPSULATION OF COMPLEX BUSINESS LOGIC” and filed on Sep. 9, 2005. The entirety of that application is hereby incorporated by reference.

### BACKGROUND

Middleware systems present an application program interface (API) through which operations can be performed, and for efficiency's sake, the API usually presents the basic atomic operations that the system recognizes. Such APIs work very well when the cost of transmitting data from an external client to the middleware system is low and when the relationship between the API and the business logic in the middleware system is easy to describe and implement.

Each of those essential qualities fails with many conventional middleware systems. The first restriction fails for access technologies like XML Web Services which depend upon loose coupling between client and middleware server which is are becoming increasingly popular because of their attractiveness when used across unreliable links like those which comprise the Internet. The second restriction fails for middleware systems that do more than simply display data (e.g., web browsers) and/or apply well-understood operations to stored data (e.g., database systems).

For example, conventional messaging and collaboration server software runs on servers and enables the sending/receiving of electronic mail and other forms of interactive communication through computer networks. Most clients access the server across the Internet, often through slow connections with significant latency. More than that, the business logic for many items typically stored inside the messaging and collaboration server software is quite subtle. For example, from the viewpoint of a client application, determining what is required to correctly accept a meeting request has proven difficult.

Worse, even if any particular operation can be performed correctly, the spectrum of available options for a given item in the messaging and collaboration server store is difficult to determine from the item type. One can respond to a meeting invitation from someone else, for instance, just as one responds to an email message. One cannot accept an email message as one can accept a meeting invitation, however, and it is not logical to accept a meeting invitation to a meeting which one organized.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A complex business logic encapsulation system is provided. The system can encapsulate complex business logic, for example, for workflow application(s). The system includes a common business logic layer component that encapsulates the business logic of objects in a store. The common business logic layer component interacts with the store via a backend data store engine.

In one example, the common business logic layer component comprises a set of XML Web services as the preferred client access technology. These services expose a class of objects called “Response Objects” which encapsulate the business logic of the complex objects in the store. The response object provides one or more suitable responses. The client application can then identify the appropriate response, populate the response, and send it back to the common business logic layer component. Further, each response object can embed an invariant identifier of the store item to which it corresponds, and, when sent or saved through the web service, causes the store to behave as if it had been processed by system.

The response object complex type in the XML schema extends the message or other complex type in the schema, adding a new required property, the reference item identifier (ID), which denotes the item relative to which the response object is to be applied. For example, a list of available responses can be enumerated in the response objects. To respond to a response object, a client application can extract one of the available responses, insert an item ID for the item recovered from the store as the reference item ID, and sends the response back to the common business logic layer component. Any other changes to the accepted item can be applied to the generated object in the store.

Optionally, this technique can be used to provide support for smart response(s), through which a client can generate a standard response to a message by sending only a small portion of the information necessary to create a personal information management object, such as a message, appointment or meeting. The server, knowing that this is a standard response, can then infer any other information necessary to fill in the response's contents. The system (e.g., store) then can handle the construction of the newly forwarded item itself.

Encapsulation of the business logic in a response object has a great many advantages beyond simply making it feasible to protect the complex business logic involved in interacting with the system. In particular, by presenting a finite list of possible operations, the system explicitly tells the client exactly what it can do, and can, therefore, prevent the client from making certain errors. In addition, since the operations are semantically coherent to clients, it becomes easier to determine what the right way to do something is. Finally, by moving the business logic from the client to the server, response objects permit the server to optimize internal operations based on its own understanding of dependencies.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features of the claimed subject matter may become apparent from the following detailed description when considered in conjunction with the drawings.

### BRIEF DESCRIPTION OF THE DRAWINGS

FIG. 1 is a block diagram of a complex business logic encapsulation system.

FIG. 2 is a block diagram of a complex business logic encapsulation architecture.

FIG. 3 is a diagram of workflow operations.

FIG. 4 is a flow chart of a method of generating a response object.

FIG. 5 is a flow chart of a method of using a response object.

FIG. 6 is a block diagram of an example operating environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “handler,” “model,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). Computer components can be stored, for example, on computer readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the claimed subject matter.

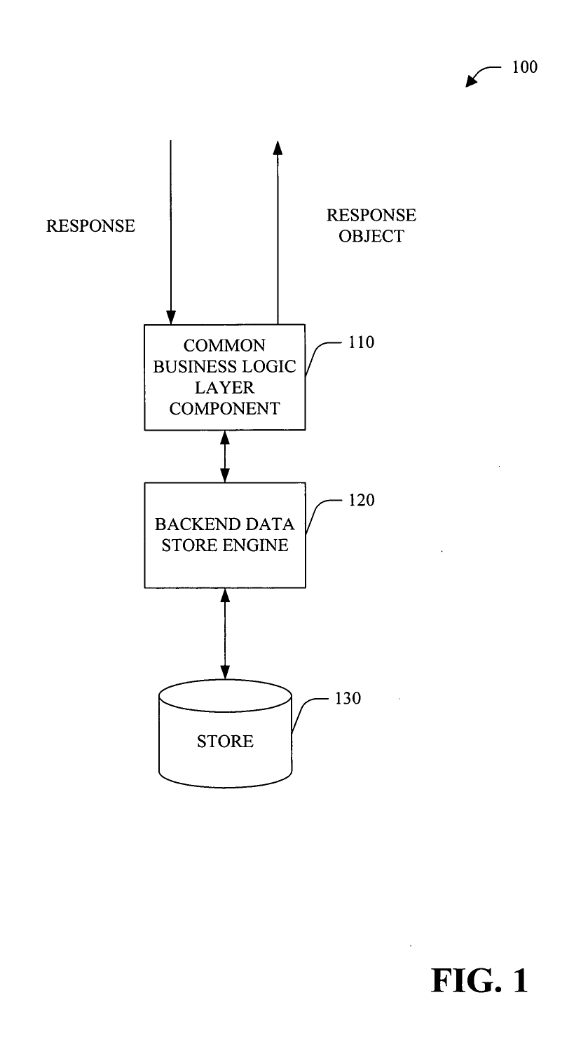

Referring to FIG. 1, a complex business logic encapsulation system 100 is illustrated. The system 100 can encapsulate complex business logic, for example, for workflow application(s). Conventional workflow application system(s) have employed multiple roundtrip messages with regard to a particular item (e.g., task). For example, a single meeting request can necessitate the exchange of a plurality of messages to have the meeting accepted and entered into a particular attendee's calendar.

The system 100 includes a common business logic layer component 110 that encapsulates the business logic of objects in a store 130 (e.g., database). In the example of FIG. 1, the common business logic layer component 110 interacts with the store 130 via a backend data store engine 120.

In one example, the common business logic layer component 110 comprises a set of XML Web services as the preferred client access technology. These services expose a class of objects called “Response Objects” which encapsulate the business logic of the complex objects in the store 130. The response object provides one or more suitable responses. The client can then identify the appropriate response, populate the response and send it back to the common business logic layer component 110.

The core abstraction involved in prescribed replies is the response object. A response object is a special class of item that has significance to the web service handler, in that it is the response to a request encoded in another message. These replies are very common in the message and collaboration world, occurring commonly in the acceptance and rejection of meetings, appointments, and tasks, and in the handling of voting buttons on standard e-mail messages. Unfortunately, the processing involved in handling response objects varies considerably from one class of items to another—accepting a meeting triggers one set of operations, but voting “Yes” triggers another—so the commonality of the user's experience is not maintained in standard APIs.

In one example, the system 100 creates the illusion of common processing by creating a class of special messages called “ResponseObjects”. Each response object can embed the invariant identifier of the store item to which it corresponds, and, when sent or saved through the web service, causes the store 130 to behave as if it had been processed by system 100 (e.g., saving a meeting deletion, for instance, deletes the meeting).

The response object complex type in the XML schema extends the message complex type in the schema, adding a new required property, the reference ID, which is a pure item id, which denotes the item relative to which the response object is to be applied. For example, for convenience, several special instances of ResponseObjectType can be created, VoteYes, VoteNo, VoteCancel, to correspond to voting Yes, No, or Cancel, respectively.

An example of such response objects is captured in the following web method response:

TABLE 1

```
<epi:GetItemsFromIdsResponse
  xmlns:cal=“http:// [...]/CalendarItem”
  xmlns:avail=“http:// [...]/Availability”
  xmlns:xs=“http://www.w3.org/2001/XMLSchema”
  xmlns:epi=“http:// [...]/base”>
  <epi:ResponseMessages>
    <epi:ResponseMessage ResponseClass=“Success” />
  </epi:ResponseMessages>
  <epi:Items>
    <cal:MeetingRequest>
      <epi:ItemId Id=“M00C0w==”/>
      <epi:TextBody>We need to get together to talk about calendar
items</epi:TextBody>
      <epi:ResponseObjects>
        <epi:AcceptItem />
        <epi:DeclineItem />
        <epi:AcknowledgeItem />
        <epi:ReplyToItem />
        <epi:ReplyAllToItem />
        <epi:ForwardItem />
      </epi:ResponseObjects>
      <cal:Subject>Calendar item talk</cal:Subject>
      <cal:Location>Rob Doe's office</cal:Location>
      <cal:StartTime>2004-12-17T16:30:00</cal:StartTime>
      <cal:EndTime>2004-12-17T17:00:00</cal:EndTime>
      <cal:IsMeeting>true</cal:IsMeeting>
      <cal:Sender>
        <epi:Mailbox>
          <epi:Name>Rob Doe </epi:Name>
          <epi:EmailAddress>robdoe</epi:EmailAddress>
          <epi:RoutingType>SMTP</epi:RoutingType>
        </epi:Mailbox>
      </cal:Sender>
      <cal:RequiredAttendees>
        <epi:Mailbox>
          <epi:Name>John Doe </epi:Name>
          <epi:EmailAddress>jdoe </epi:EmailAddress>
          <epi:RoutingType>SMTP</epi:RoutingType>
        </epi:Mailbox>
        <epi:Mailbox>
          <epi:Name>Jim Doe </epi:Name>
          <epi:EmailAddress>jimdoe</epi:EmailAddress>
          <epi:RoutingType>SMTP</epi:RoutingType>
        </epi:Mailbox>
        <cal:AssociatedCalenderItemID Id=“Fr00goo=” />
      </cal:RequiredAttendees>
    </cal:MeetingRequest>
  </epi:Items>
</epi:GetItemsFromIdsResponse>
```

The list of available response objects is enumerated in the ResponseObjects element:

TABLE 2

```
<epi:ResponseObjects>
      <epi:AcceptItem />
      <epi:DeclineItem />
      <epi:AcknowledgeItem />
      <epi:ReplyToItem />
      <epi:ReplyAllToItem />
      <epi:ForwardItem />
  </epi:ResponseObjects>
```

To accept the meeting, the recipient (e.g., client component, discussed below) extracts the AcceptItem object from this packet, inserts the item id for the item recovered from the store 130 as the reference item id, and sends the response back to the common business logic layer component 110. Any other changes to the accepted item can be applied to the generated object in the store 130. For instance, the attendee can accept the meeting request by making the following web method call:

TABLE 3

```
<epi:CreateItem
  xmlns:epi=“http:// [...]/base”>
  <epi:Items>
    <epi:AcceptItem>
      <epi:ReferenceItemId Id=“Fr00goo=”/>
    </epi:AcceptItem>
  </epi:Items>
</epi:CreateItem>
```

Optionally, this technique can be used to provide support for smart response(s), through which a client can generate a standard response to a message by sending only a small portion of the information necessary to create a message or PIM object. The server, knowing that this is a standard response, can then infer any other information necessary to fill in the response's contents. As an example, suppose a calendar item is retrieved from the store, and the following blob is obtained.

TABLE 4

```
<epi:GetItemResponse xmlns:epi=“http://[...]/base”
  xmlns:cal=“http://[...]/CalendarItem”>
  <epi:ResponseMessages>
    <epi:ResponseMessage ResponseClass=“Success” />
  </epi:ResponseMessages>
  <epi:Items>
    <cal:CalendarItem>
      <epi:ItemId Id=“Foogoo==”/>
      <cal:Subject>Test Meeting</cal:Subject>
      <cal:StartTime>2004-11-15T19:45:00</cal:StartTime>
      <cal:EndTime>2004-11-15T19:45:00</cal:EndTime>
    </cal:CalendarItem>
  </epi:Items>
</epi:GetItemResponse>
```

The key part of code of Table 4 is the CalendarItem itself. Forwarding it is not as simple as it seems, as there is a significant amount of work involved in creating the forwarded object. Alternatively, the user can use the smart forwarding behavior for calendar items:

TABLE 5

```
<epi:ForwardItem xmlns:epi=“http://[...]/base”
  xmlns:cal=“http://[...]/CalendarItem”>
  <epi:ToRecipients>
    <epi:Mailbox>
      <epi:Name>Bob Doe </epi:Name>
      <epi:EmailAddress>bobdoe</epi:EmailAddress>
      <epi:RoutingType>SMTP</epi:RoutingType>
    </epi:Mailbox>
  </epi:ToRecipients>
  <epi:ReferenceItemId Id=“Foogoo==”/>
</epi:ForwardItem>
```

The system 100 (e.g., store 130 ) then can handle the construction of the newly forwarded item itself.

Encapsulation of the business logic in a response object has a great many advantages beyond simply making it feasible to protect the complex business logic involved in interacting with the system 100. In particular, by presenting a finite list of possible operations, the system 100 explicitly tells the client exactly what it can do, and can, therefore, prevent the client from making certain errors. In addition, since the operations are semantically coherent to clients, it becomes easier to determine what the right way to do something is. Finally, by moving the business logic from the client to the server, response objects permit the server to optimize internal operations based on its own understanding of dependencies.

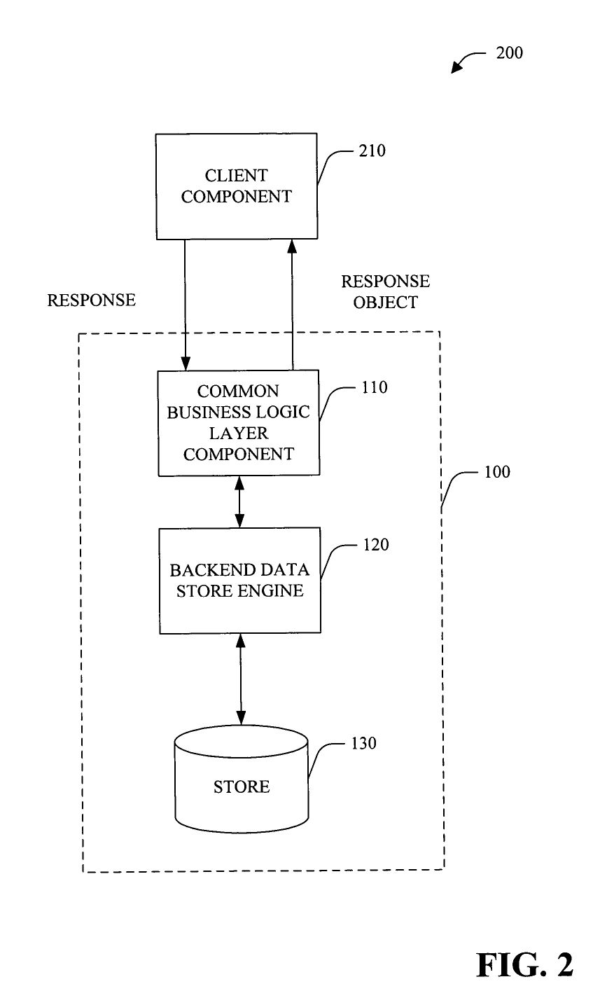

Turning to FIG. 2, a complex business logic encapsulation architecture 200 is illustrated. The architecture 200 includes a common business logic layer component 110, a backend data store engine 120, a store 130 and a client component 210. The client component 210 can communicate with the common business logic layer component 110, for example, via an intranet, the Internet etc.

In one example, the client component 210 interacts with the complex business logic encapsulation system 100 via XML Web services which expose a class of response objects which encapsulate the business logic of the complex objects in the store 130 (as discussed previously). For example, the system 100 can provide a web method response to the client component 210 which include one or more suitable responses. The client component 210 can identify an appropriate response, populate the response and send it back to the system 100.

### EXAMPLE

### Creation of Response Objects

When an item with response buttons or default responses is read from the store 130, synthetic responses for each of those response buttons can be created by the common business logic layer component 110. The types, reference entity ID, and basic data for the response can be pre-populated into the response objects for each button or prescribed response.

### Default Sets of Response Objects

A base list of common response object types associated with an item can be a part of the default shape for that item. Exemplary the response objects available in some common cases are enumerated in Table 6 (e.g., default response objects supported when no response object templates are specified).

TABLE 6

| Item type | Default response objects |
|---|---|
| Appointment request, meeting request | ForwardItem, ReplyToItem, |
| | ReplyAllToItem, |
| | RecallItem |
| Task request | ForwardItem, ReplyToItem, |
| | ReplyAllToItem, RecallItem |
| Contact | ForwardItem |
| Task | ForwardItem, ReplyToItem, |
| | ReplyAllToItem, RecallItem, |
| | SmartStatusReport |
| Other item type derived from Message | ForwardItem, ReplyToItem, |
| | ReplyAllToItem, RecallItem |

### Processing of a Response Object

A client program desiring to send a prescribed response can extract the corresponding response object from the XML sent by the system 100, and send that particular message. The system 100 checks that the item type for the received message is consistent with the type of the item to which it corresponds, so that client programs do not send back meeting request acceptances to task requests, for instance. After that, the system 100 generates the correct behavior to replicate the behavior which the messaging/collaboration server software exhibits on objects of the relevant type.

### Response Objects in the Store

Response objects can also be saved in the store 130 through an XML Web service. Such a save does not merely save the object, but can also trigger the operation(s) which would normally be triggered by saving such an object. For instance, if a form for editing a response to a meeting request acceptance is saved while in the messaging/collaboration server software, the meeting gets accepted; all that gets saved is the specially typed message which could be sent to the recipient.

### Voting Buttons

Most reply objects are added to items in the store automatically. In one example, “Voting buttons” are an exception: if a message is associated with a set of voting buttons, those voting buttons must be added as voting button objects to the message itself.

For example, to create a voting button, the following call can be made:

TABLE 7

```
<exch:CreateItem xmlns:exch=“http:// [...]/base”>
  <exch:Items>
    <exch:Message>
      <exch:TextBody>
        Hi there!
      </exch:TextBody>
      <exch:ResponseObjects>
        <exch:VoteYes />
        <exch:VotingButton ObjectName=“Forty-two” />
      </exch:ResponseObjects>
      <exch:ToRecipients>
        <exch:Mailbox>
          <exch:Name>John Doe </exch:Name>
          <exch:EmailAddress>johndoe</exch:EmailAddress>
          <exch:MailboxType>SMTP</exch:MailboxType>
        </exch:Mailbox>
      </exch:ToRecipients>
    </exch:Message>
  </exch:Items>
</exch:CreateItem>
```

The recipient can vote “forty-two” with the following response.

TABLE 8

```
<exch:CreateItem xmlns:exch=“http:// [...]/base”>
  <exch:Items>
    <exch:VotingButton ObjectName=“Forty-two”>
      <exch:ReferenceItemId Id=“fugu2you” />
    </exch:VotingButton>
  </exch:Items>
</exch:CreateItem>
```

### Filling in smart responses from smart response objects

In one example, there are three universal response objects, ReplyToltem, ReplyAlIToItem, and ForwardItem. All messages can be responded to with universal response objects except for contacts; contacts can be forwarded, but not replied to. All fields for any given object are cleared during a smart response, except as specified in Table 9 (behavior of fields during smart responses).

TABLE 9

| Item type | Field | Operation |
|---|---|---|
| All | Item type | In all cases except for forwarding of |
| | | tasks and calendar items, the new item |
| | | type shall be IPM.Note. In the case of |
| | | forwarded tasks and calendar items, |
| | | the new item shall be a task or a |
| | | calendar item, as appropriate. |
| All | Subject | Correct prefix for operation is |
| | | prepended to base subject for original |
| | | message. This prefix can be computed |
| | | using an algorithm based on a stored |
| | | preferred culture value, if that is |
| | | available, on the culture header sent |
| | | from the client, if that is available, or |
| | | from the default culture for the server. |
| All | To: | Reply - Sender of original note |
| | | Forward - as specified in ForwardItem |
| | | element |
| | | Reply all - All entities in original To: |
| | | list, with respondent removed if |
| | | present, and with the original sender's |
| | | address prepended to the list of |
| | | recipients |
| All | CC: | Response, Forward - empty |
| | | Response all - All entities in original |
| | | Cc: list with respondent removed if |
| | | present. |
| All | Bcc: | Always empty |
| Message | Text body | If the smart response operation |
| | | specifies a “NewTextBodyContent”, |
| | | then the text body consists of the new |
| | | header followed by the old body. If |
| | | the smart response operation specifies |
| | | a “NewFormattedBodyContent” but |
| | | not “NewTextBodyContent”, then the |
| | | formatted body shall be extracted from |
| | | the store as if it were plain text, the |
| | | new formatted body prepended onto it, |
| | | and the textual content of the merged |
| | | bodies will be used as the new text |
| | | body. If neither is specified, the |
| | | current text body will be retained. |
| Message | Formatted body | If the smart response object specifies |
| | | “NewFormattedBodyContent”, then |
| | | the formatted body shall be extracted |
| | | from the store, the new formatted body |
| | | prepended onto it. If the smart |
| | | response object specifies |
| | | “NewTextBodyContent” but not |
| | | “NewFormattedBodyContent”, then |
| | | the formatted body will be updated, if |
| | | necessary, by prepending the specified |
| | | text to the formatted body. If neither |
| | | is specified, then the current formatted |
| | | body will be retained. |
| All | Attachments | For all items except contacts, |
| | | attachments will be cleared for |
| | | response and response all cases, and |
| | | any attachments will be preserved in |
| | | the case of forwarding. In the case of |
| | | contacts, the contact card itself shall |
| | | be included in the smart forward |
| | | message as the sole attachment. |

### Recalling Messages

For sent or posted messages “from” the current user, a special response object called a “RecallItem” object can be supported which shall cause a recall message to be issued. This can be considered to be a default option in all cases where a message is taken to be from the current user or from a delegate.

It is to be appreciated that the system 100, the common business logic layer component 110, the backend data store engine 120, the store 130, the system 200 and/or the client component 210 can be computer components as that term is defined herein.

### Conventional Messaging and Collaboration System(s)

Messaging and collaboration server software offers its users the ability to perform routine operations on personal and shared information management items, allowing them to accept meetings, vote yes or no on proposals, and propose that items be rescheduled. In addition, responders can specify or modify the message body associated with such operations. Such operations are supported by the creation of specially constructed response messages which contain not only the user-visible operations, but also hidden data which allows the server to associate the response with its associated object, and, if necessary, to modify that object.

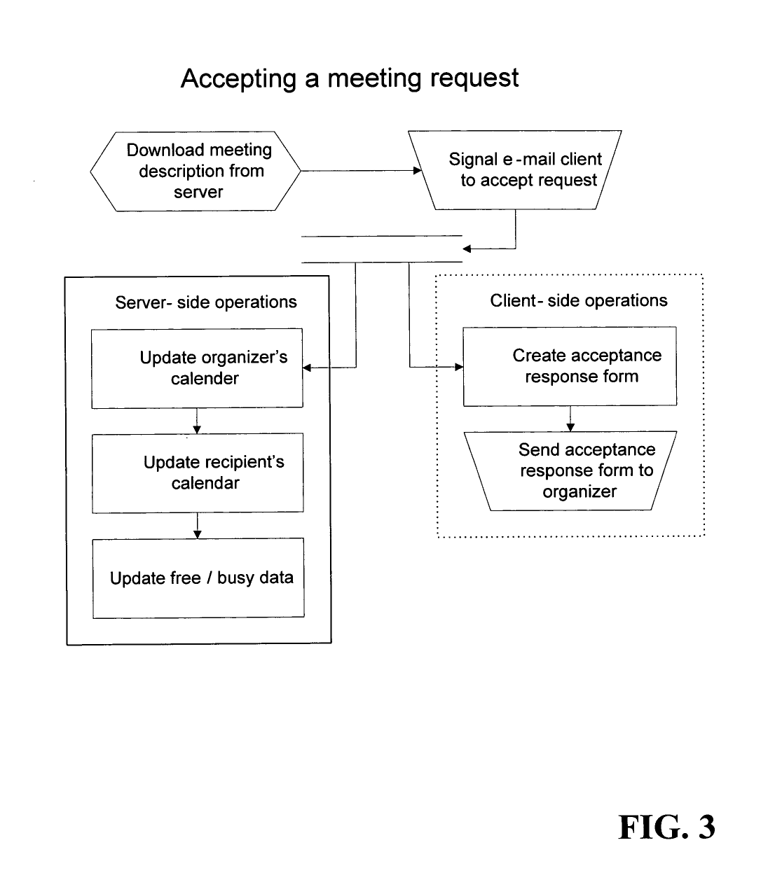

Conventionally, replicating the workflow which underlies those operations is complicated and expensive. Consider the steps required to accept a meeting request, shown in FIG. 3. In order to implement this process in a standards-based protocol such as WebDAV, each of the stages in the acceptance process must be correctly executed, requiring as many as seven round-trips to the server. That process is both delicate and expensive.

There are other difficulties with prescribed response handling. When a prescribed response is processed by the server, the object with which it is associated must be updated to reflect the response. This requirement clashes with the needs of third party application developers, who often wish to add custom properties to items to mark those items for special handling. For security reasons, when clients reconstruct the items after these responses, they typically only preserve items that they “understand”, and, as a result, those custom markers are lost.

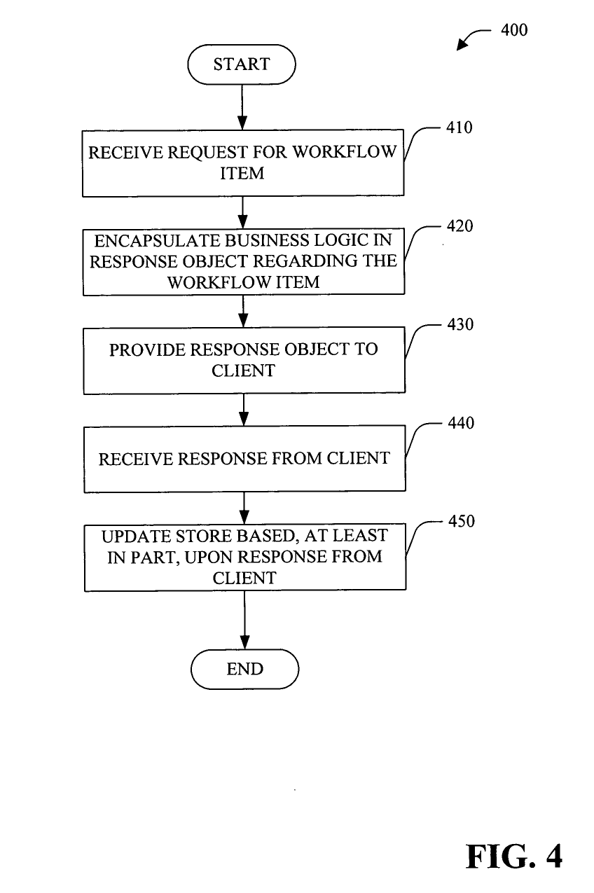

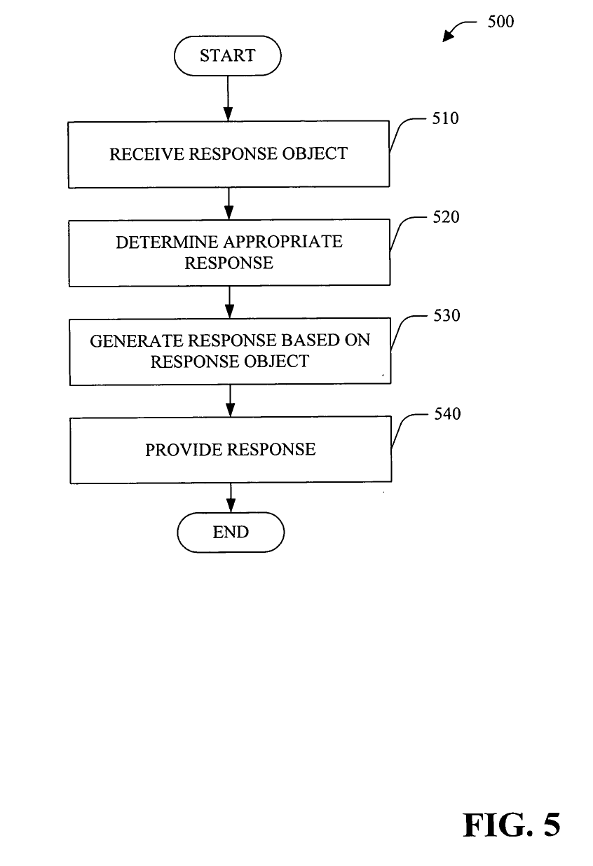

Turning briefly to FIGS. 4 and 5, methodologies that may be implemented in accordance with the claimed subject matter are illustrated. While, for purposes of simplicity of explanation, the methodologies are shown and described as a series of blocks, it is to be understood and appreciated that the claimed subject matter is not limited by the order of the blocks, as some blocks may, in accordance with the claimed subject matter, occur in different orders and/or concurrently with other blocks from that shown and described herein. Moreover, not all illustrated blocks may be required to implement the methodologies.

The claimed subject matter may be described in the general context of computer-executable instructions, such as program modules, executed by one or more components. Generally, program modules include routines, programs, objects, data structures, etc. that perform particular tasks or implement particular abstract data types. Typically the functionality of the program modules may be combined or distributed as desired in various embodiments.

Referring to FIG. 4, a method of generating a response object is illustrated. At 410, a request for a workflow item is received. For example, the workflow item can be a meeting request, an email message etc. At 420, business logic associated with the work flow item is encapsulated in a response object.

At 430, the response object is provided to a client. At 440, a response is received from the client. At 450, a store (e.g., store 130 ) is updated based, at least in part, upon the response from the client.

Turning to FIG. 5, a method of using a response object is illustrated. At 510, a response object is received, for example, as a web method response. At 520, an appropriate response is determined, for example, based upon one or more suitable responses included in the response object.

At 530, a response is generated based on the response object. For example, one or the suitable responses included in the response object can be extracted along with an item identifier. At 540, the response is provided, for example, to a common business logic layer component.

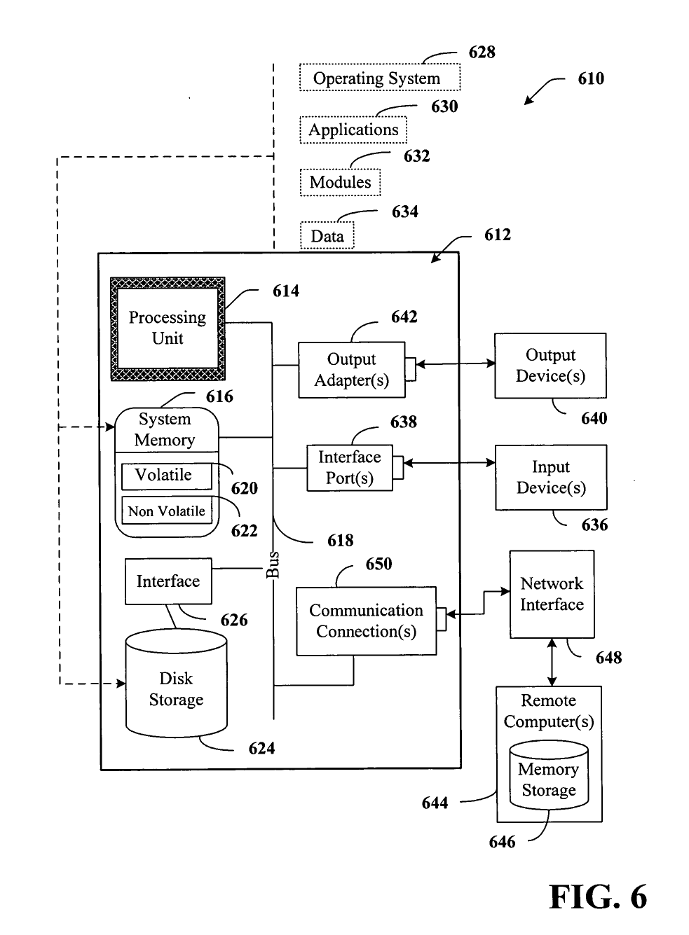

In order to provide additional context for various aspects of the claimed subject matter, FIG. 6 and the following discussion are intended to provide a brief, general description of a suitable operating environment 610. While the claimed subject matter is described in the general context of computer-executable instructions, such as program modules, executed by one or more computers or other devices, those skilled in the art will recognize that the claimed subject matter can also be implemented in combination with other program modules and/or as a combination of hardware and software. Generally, however, program modules include routines, programs, objects, components, data structures, etc. that perform particular tasks or implement particular data types. The operating environment 610 is only one example of a suitable operating environment and is not intended to suggest any limitation as to the scope of use or functionality of the claimed subject matter. Other well known computer systems, environments, and/or configurations that may be suitable for use with the claimed subject matter include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 6, an exemplary environment 610 includes a computer 612. The computer 612 includes a processing unit 614, a system memory 616, and a system bus 618. The system bus 618 couples system components including, but not limited to, the system memory 616 to the processing unit 614. The processing unit 614 can be any of various available processors. Dual microprocessors and other multiprocessor architectures also can be employed as the processing unit 614.

The system bus 618 can be any of several types of bus structure(s) including the memory bus or memory controller, a peripheral bus or external bus, and/or a local bus using any variety of available bus architectures including, but not limited to, an 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 616 includes volatile memory 620 and nonvolatile memory 622. The basic input/output system (BIOS), containing the basic routines to transfer information between elements within the computer 612, such as during start-up, is stored in nonvolatile memory 622. By way of illustration, and not limitation, nonvolatile memory 622 can include read only memory (ROM), programmable ROM (PROM), electrically programmable ROM (EPROM), electrically erasable ROM (EEPROM), or flash memory. Volatile memory 620 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 612 also includes removable/nonremovable, volatile/nonvolatile computer storage media. FIG. 6 illustrates, for example a disk storage 624. Disk storage 624 includes, but is not limited to, devices like a magnetic disk drive, floppy disk drive, tape drive, Jaz drive, Zip drive, LS-100 drive, flash memory card, or memory stick. In addition, disk storage 624 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 624 to the system bus 618, a removable or non-removable interface is typically used such as interface 626.

It is to be appreciated that FIG. 6 describes software that acts as an intermediary between users and the basic computer resources described in suitable operating environment 610. Such software includes an operating system 628. Operating system 628, which can be stored on disk storage 624, acts to control and allocate resources of the computer system 612. System applications 630 take advantage of the management of resources by operating system 628 through program modules 632 and program data 634 stored either in system memory 616 or on disk storage 624. It is to be appreciated that the claimed subject matter can be implemented with various operating systems or combinations of operating systems.

A user enters commands or information into the computer 612 through input device(s) 636. Input devices 636 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 614 through the system bus 618 via interface port(s) 638. Interface port(s) 638 include, for example, a serial port, a parallel port, a game port, and a universal serial bus (USB). Output device(s) 640 use some of the same type of ports as input device(s) 636. Thus, for example, a USB port may be used to provide input to computer 612, and to output information from computer 612 to an output device 640. Output adapter 642 is provided to illustrate that there are some output devices 640 like monitors, speakers, and printers among other output devices 640 that require special adapters. The output adapters 642 include, by way of illustration and not limitation, video and sound cards that provide a means of connection between the output device 640 and the system bus 618. It should be noted that other devices and/or systems of devices provide both input and output capabilities such as remote computer(s) 644.

Computer 612 can operate in a networked environment using logical connections to one or more remote computers, such as remote computer(s) 644. The remote computer(s) 644 can be a personal computer, a server, a router, a network PC, a workstation, a microprocessor based appliance, a peer device or other common network node and the like, and typically includes many or all of the elements described relative to computer 612. For purposes of brevity, only a memory storage device 646 is illustrated with remote computer(s) 644. Remote computer(s) 644 is logically connected to computer 612 through a network interface 648 and then physically connected via communication connection 650. Network interface 648 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 650 refers to the hardware/software employed to connect the network interface 648 to the bus 618. While communication connection 650 is shown for illustrative clarity inside computer 612, it can also be external to computer 612. The hardware/software necessary for connection to the network interface 648 includes, for exemplary purposes only, internal and external technologies such as, modems including regular telephone grade modems, cable modems and DSL modems, ISDN adapters, and Ethernet cards.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented complex business logic encapsulation system comprising the following computer executable components:
a backend data store engine that interacts with a data store that stores information related to workflow; and,
a common business logic layer component that provides a response object that encapsulates business logic associated with a particular workflow.

2. The system of claim 1, the encapsulated business logic comprising one or more suitable responses from a client.

3. The system of claim 1, the common business logic layer component comprising one or more XML Web services.

4. The system of claim 3, the response object provides as a web method response.

5. The system of claim 1, the response object comprising an XML schema including a reference identifier that denotes an item relative to which the response object is to be applied.

6. The system of claim 1, further comprising a client component that receives the response object, identifies the appropriate response, populates the response and sends it back to the common business logic layer component.

7. The system of claim 1, further comprising a client component that generates a standard response to the response object, the standard response comprising a portion of the necessary information, the common business logic layer component infers a remainder of the necessary information.

8. The system of claim 1, the response object comprises an embedded invariant identifier of a store item to which it corresponds.

9. The system of claim 1, the common business logic layer component generates the response object based on a type of item, the response object comprising a plurality of potential responses, each potential response including a type, a reference entity identifier and basic data for the response.

10. The system of claim 9, for an appointment and/or meeting request, the common business logic layer component generates default response objects of forward item and reply to item.

11. A computer implemented method of generating a response object comprising the following computer executable acts:
receive a request for a workflow item;
encapsulating business logic associated with the workflow item in a response object; and, providing the response object to a client.

12. The method of claim 11, the encapsulated business logic comprising one or more suitable responses from the client.

13. The method of claim 11, the response object is based upon an XML schema.

14. The method of claim 11, the response object including a reference identifier that denotes an item relative to which the response object is to be applied.

15. The method of claim 11, further comprising receiving the response object as modified by a client component.

16. The method of claim 11, further comprising determining whether an item type of the response object is consistent with a type of an item to which it corresponds.

17. A computer implemented method of using a response object comprising the following computer executable acts:
receiving the response object;
determining an appropriate response based, at least in part, upon one or more suitable responses included in the response object;
generating a response based on the one or more suitable responses included in the response object; and,
providing the response.

18. The method of claim 17, the response object is based upon an XML schema.

19. The method of claim 17, determining an appropriate response further comprising receiving user input.

20. The method of claim 17, the response comprising one of the suitable responses extracted from the response object and an item identifier extracted from the response object.
